(19) United States
(12) Patent Application Publication
(10) Pub. No.: US 2015/0284166 A1
(43) Pub. Date: Oct. 8, 2015

(54) APPLICATOR ASSEMBLIES AND METHODS FOR DISPENSATION OF COMPOSITION COMPRISING PHOSPHORESCENT MATERIAL

(71) Applicant: Zachary L. Green, Cincinnati, OH (US)

(72) Inventor: Zachary L. Green, Cincinnati, OH (US)

(21) Appl. No.: 14/437,541

(22) PCT Filed: Oct. 25, 2013
(86) PCT No.: PCT/US2013/066734

§ 371 Date: Apr. 22, 2015

Related U.S. Application Data
(60) Provisional application No. 61/720,190, filed on Oct. 30, 2012.

(51) Int. Cl. B65D 81/32; B05C 17/01; B05C 11/10; B05C 17/005

(52) U.S. Cl. CPC B65D 81/325; B05C 17/00576; B05C 17/012; B05C 11/10; B65D 81/3255

(57) ABSTRACT

A method for using an applicator assembly includes coupling a cartridge with a gun. The cartridge includes first and second chambers filled at least partially with a first component and a second component, respectively. At least one of the first and second components includes a phosphorescent material. A nozzle is attached to the cartridge and is provided in fluid communication with an opening in the cartridge and with the first and second chambers. A piston of the gun is moved relative to the cartridge to facilitate simultaneous dispensation of the first and second components through the opening and into the nozzle. The first and second components mix, within the nozzle, into a composition which is dispensed through an aperture in the nozzle. Cartridges, applicator assemblies, and kits are also provided.

### CROSS REFERENCE TO RELATED APPLICATION

This application claims the priority benefit of U.S. Provisional Patent Application Ser. No. 61/720,190, “Applicator Assemblies And Methods For Dispensation Of Composition Comprising Phosphorescent Material”, filed Oct. 30, 2012, which is hereby expressly incorporated by reference herein in its entirety.

### TECHNICAL FIELD

This application relates generally to applicator assemblies and methods for dispensation of composition comprising phosphorescent material.

### BACKGROUND

Conventional methods of applying phosphorescent compositions are overly difficult, time-intensive, and expensive.

### SUMMARY

In accordance with a first embodiment, a method is provided for using an applicator assembly. The method comprises coupling a cartridge with a gun, such that a piston of the gun enters a bore in a distal end of the cartridge. The cartridge comprises a first chamber and a second chamber. The first chamber is filled at least partially with a hardener, and the second chamber is filled at least partially with a resin. At least one of the resin and the hardener comprises a phosphorescent material. The method further comprises providing an opening in a proximal end of the cartridge, and attaching a distal end of a nozzle to the proximal end of the cartridge, such that the nozzle is provided in fluid communication with the opening, the first chamber, and second chamber. The method additionally comprises moving the piston proximally relative to the cartridge to facilitate simultaneous dispensation of the hardener and the resin through the opening and into the nozzle. The method also comprises mixing, within the nozzle, the hardener and the resin into a composition. The composition comprises an epoxy. The method also comprises dispensing the composition through an aperture in a proximal end of the nozzle.

In accordance with a second embodiment, a cartridge comprises a side wall, a first chamber, a second chamber, and an opening. The side wall defines a cylindrical exterior shape extending coaxially about a longitudinal axis between opposed distal and proximal ends. The distal end opens to a bore defined at least partially by the side wall. The bore is configured to selectively receive at least a portion of a piston of a gun. The first chamber is disposed at least partially within the bore and is filled at least partially with a first component. The second chamber is disposed at least partially within the bore and is filled at least partially with a second component. The opening is defined in the proximal end and is in fluid communication with the first chamber and the second chamber. The first component and the second component are configured to simultaneously dispense through the opening in selective response to movement of a piston of a gun within the bore. At least one of the first component and the second component comprises a phosphorescent material.

In accordance with a third embodiment, an applicator assembly comprises the cartridge of the second embodiment above in combination with a nozzle. The nozzle comprises a distal end and a proximal end. The proximal end of the nozzle defines an aperture. The distal end of the nozzle is configured for attachment to the proximal end of the cartridge, such that the nozzle is in fluid communication with the opening, the first chamber, and second chamber.

In accordance with a fourth embodiment, a kit comprises the applicator assembly of the third embodiment above in combination with at least one of a chemical cleaner, an abrasive pad, a brush, a putty knife, grit, and a coating.

### BRIEF DESCRIPTION OF THE DRAWINGS

Various embodiments will become better understood with regard to the following description, appended claims and accompanying drawings wherein:

FIG. 1 is a perspective view depicting an applicator assembly in accordance with one embodiment, wherein a cartridge is coupled with a gun, a nozzle is attached to the cartridge, and a piston and a portion of a piston rod of the gun are shown in dashed lines to be received within a bore of the cartridge;

FIG. 2 is a perspective view depicting an operator dispensing composition from the applicator assembly of FIG. 1 onto surfaces of a staircase;

FIG. 3 is a perspective view depicting the staircase of FIG. 2 with the composition smooth and tape removed;

FIG. 4 is a perspective view depicting the staircase of FIG. 3 when ambient light is removed, leaving the composition on the staircase visible to provide a “glow”; and

FIG. 5 is a side elevational view, shown partially in cross-section and schematic, of the nozzle and a portion of the cartridge of FIG. 1, and in association with the piston and a portion of the piston rod of the gun of FIG. 1.

### DETAILED DESCRIPTION

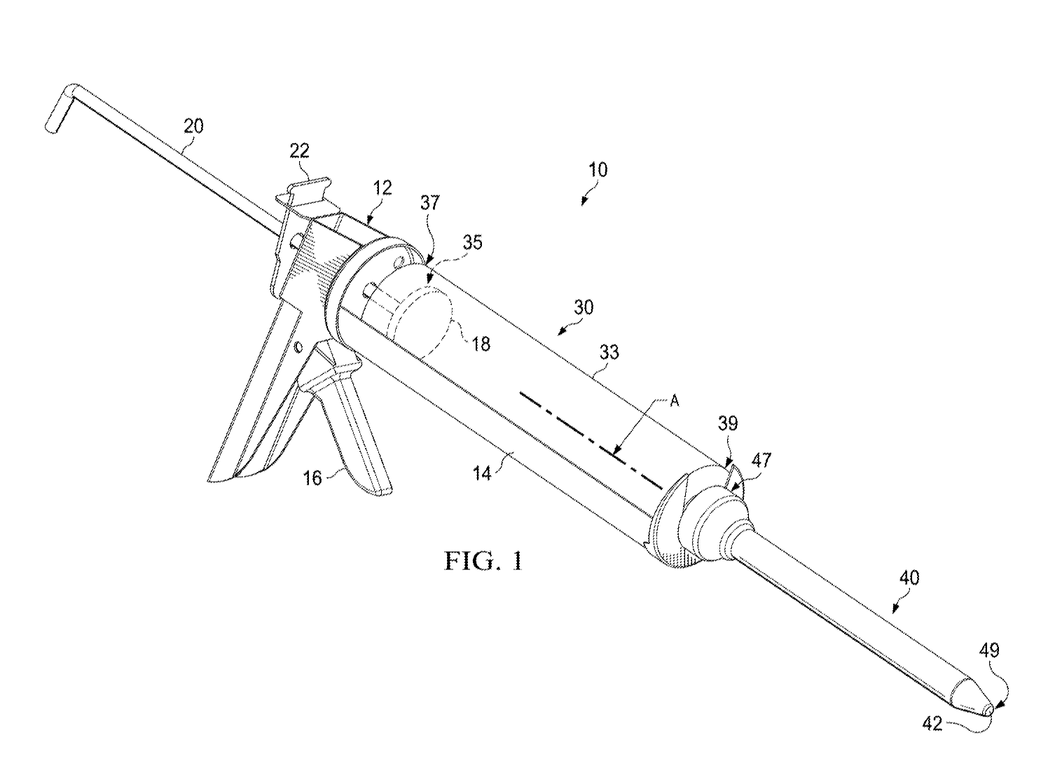

Selected embodiments are hereinafter described in detail in connection with the views and examples of FIGS. 1-5, wherein like numbers illustrate like elements throughout the views.

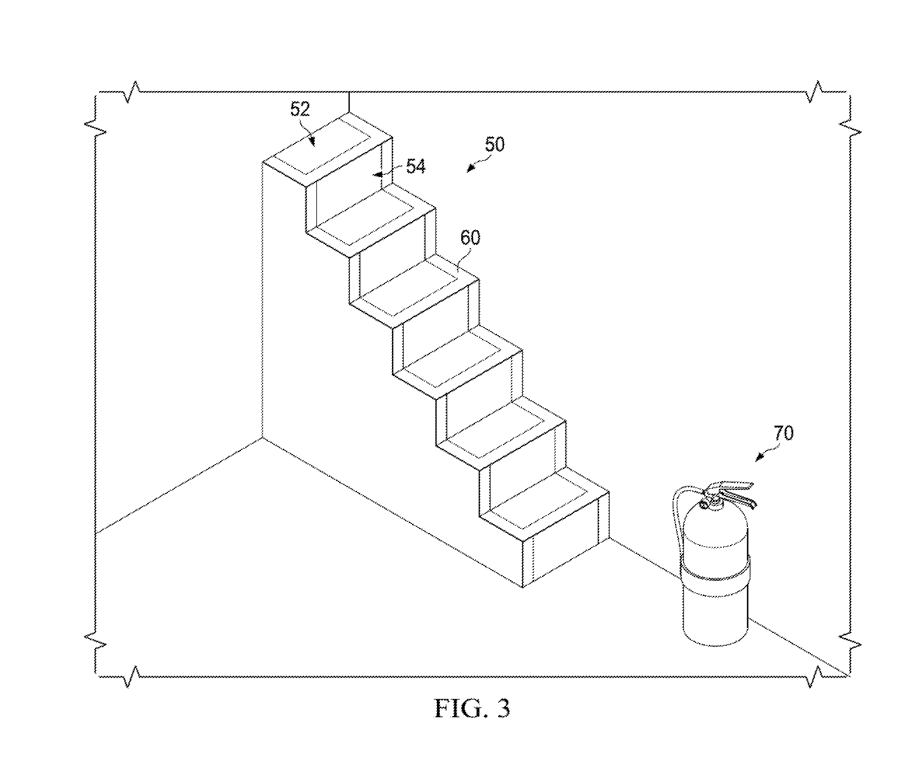

A composition comprising a phosphorescent material can be applied to surfaces to facilitate visibility of the surfaces in conditions of otherwise low ambient light. In one embodiment, such surfaces can be provided by products comprising any of a variety of tools such as axes, hammers, fire extinguishers (e.g., 70 in FIG. 3), flashlight bodies, and other tools or items for use by firefighters, police officers, military personnel, other public service workers, janitorial and maintenance workers, and others. In other embodiments, such surfaces can comprise floor surfaces, wall surfaces, and ceiling surfaces of buildings or other structures, and/or of body panels or other components of land-based, water-based, and air-based vehicles or equipment. Any of a variety of suitable methods can be used to apply compositions having phosphorescent materials to such surfaces. The method used to apply such a composition can be selected based upon the type of surface, and the particular type of composition or phosphorescent material included therein.

In one embodiment, a composition can be formed as a mixture of multiple components. For example, a composition can be a polymer-based material, such as an epoxy, formed as a 2-part mixture of a resin and a hardener. In one example, each of the resin and the hardener of the epoxy can include a phosphorescent material. In another example, only one of the resin and the hardener of the epoxy can include a phosphorescent material. One such phosphorescent material that can be used is a phosphorescent phosphor. Any of a variety of phosphorescent phosphors can be selected for inclusion in the resin and/or the hardener such as, for example, those of a type disclosed in U.S. Pat. No. 5,424,006 issued Jun. 13, 1995, the entire disclosure of which is hereby incorporated by reference herein in its entirety. For example, the phosphorescent phosphor can comprise photoluminescent strontium aluminum based pigment which, along with one or more other materials to prevent pigment settling and ensure emulsion, can be added to each of the hardener and the resin. It will be appreciated that other types of phosphorescent materials can alternatively be provided in one or both of the resin and the hardener of an epoxy. For example, in one alternative embodiment, the phosphorescent phosphor can comprise a photoluminescent zinc oxide based material.

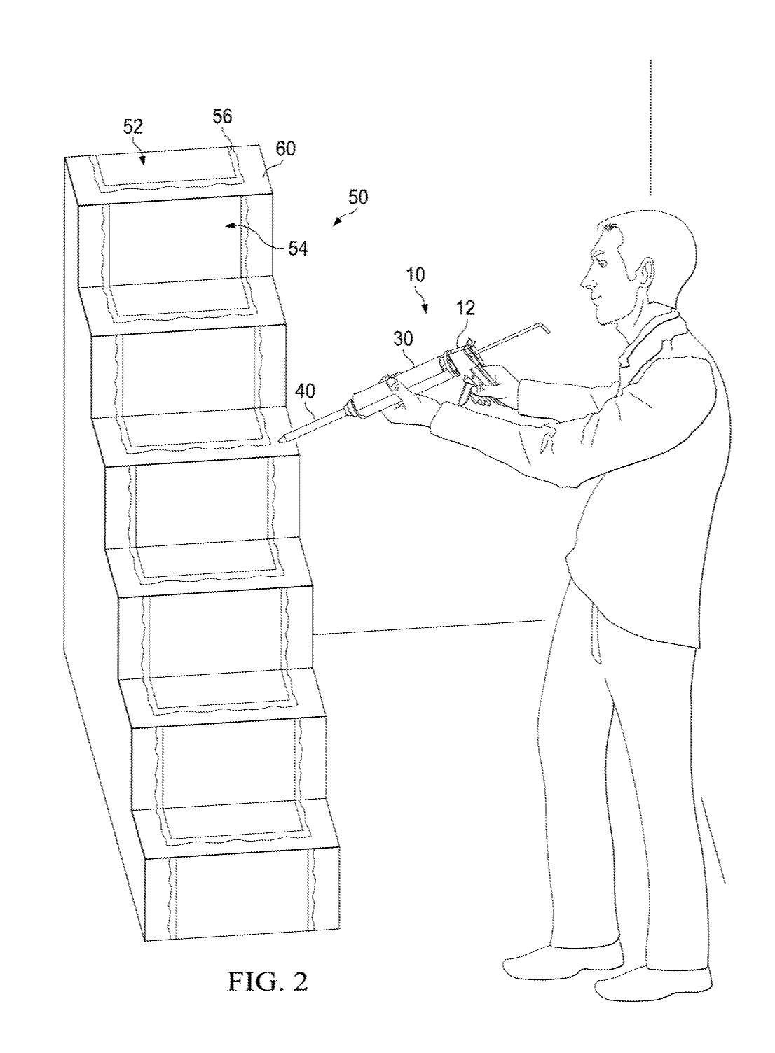

An operator can use an applicator assembly 10 to facilitate application of a composition 60 having a phosphorescent material to a surface (e.g., horizontal and vertical stair surface 52 and 54 of a staircase 50, as shown for example in FIG. 2). As shown in FIG. 1, the applicator assembly 10 can include a gun 12, a cartridge 30, and a nozzle 40. The gun 12 can comprise a conventional caulk-type gun having a body 14 and a handle 16 that is pivotable relative to the body 14 to facilitate forward linear translation of a piston rod 20 relative to the body 14. The gun 12 can also include a lock 22 that can facilitate selective prevention of rearward linear translation of the piston rod 20 relative to the body 14. A piston 18 (shown in dashed lines in FIG. 1) can be provided on a proximal end of the piston rod 20 and received into a bore 35 formed in a distal end 37 of the cartridge 30. With the lock 22 engaged, when the handle 16 is pumped or squeezed by an operator relative to the body 14, the piston 18 and piston rod 20 can move proximally relative to the body 14 to facilitate pressurization and dispensation of the components of the composition 60 within and from the cartridge 30.

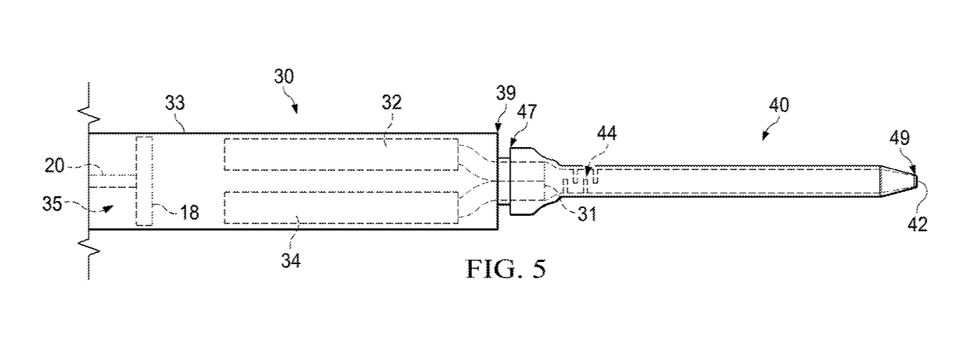

The cartridge 30 can have a side wall 33 defining a cylindrical exterior shape of the cartridge 30 extending coaxially about a longitudinal axis “A” between opposed distal and proximal ends 37 and 39, as shown in FIG. 1, so as to be suitable for effective coupling of the cartridge 30 with a conventional caulk-type gun such as the gun 12 of FIG. 1. In one embodiment, the cartridge 30 can comprise a multi-chamber fluid cartridge, with the resin and the hardener each having been filled into separate chambers, respectively, of the multi-chamber fluid cartridge. For example, the cartridge 30 can comprise a dual-chamber fluid cartridge, such as of a type marketed as the U-TAH™ UNIVERSAL CARTRIDGE SYSTEM by TAH Industries Inc. of Robbinsville, N.J. USA (herein the “U-TAH™ SYSTEM”), and/or disclosed in U.S. Pat. No. 6,848,480 issued Feb. 1, 2005, U.S. Pat. No. 7,237,693 issued Jul. 3, 2007, U.S. Pat. No. 7,497,355 issued Mar. 3, 2009, and/or U.S. Pat. No. 7,506,783 issued Mar. 24, 2009 (herein collectively the “Cartridge Patents”). The entire disclosure of each of the Cartridge Patents is hereby incorporated by reference herein in its entirety. For example, as shown schematically in FIG. 5, the cartridge 30 can include a first chamber 32 and a second chamber 34.

In one embodiment, when the composition 60 comprises an epoxy, the hardener of the epoxy can be provided within a first chamber (e.g., 32 in FIG. 5) of the cartridge 30, and the resin of the epoxy can be provided within a second chamber (e.g., 34 in FIG. 5) of the cartridge 30. In one example, the dual-chamber fluid cartridge can comprise part # 7702991 (CK-820-01A), a U-TAH™ SYSTEM fluid cartridge having a ratio of about 2:1. In such a configuration, the cartridge 30 can contain about twice as much resin as hardener, and during dispensation of the composition 60 from the cartridge 30 through use of the gun 12 (as described more fully below), about two parts of resin can be dispensed for about every one part of hardener that is simultaneously dispensed. However, it will be appreciated that the cartridge 30 can alternatively be provided in a different configuration. For example, in one alternative embodiment, the cartridge 30 can contain about twice as much hardener as resin, and during dispensation of the composition 60 from the cartridge 30 through use of the gun 12 (as described more fully below), about two parts of hardener can be dispensed for about every one part of resin that is simultaneously dispensed. In still other embodiments, the cartridge can have its two chambers provided in a different ratio relative to one another, e.g., a resin/hardener or hardener/resin ratio of about 1:1, about 1.25:1, about 1.5:1, about 1.75:1, about 2.25:1, about 2.5:1, about 2.75:1, about 3:1, about 4:1, about 5:1, about 6:1, about 7:1, about 8:1, about 9:1, about 10:1, about 20:1, or about 50:1, or with more than two chambers.

When the cartridge 30 is coupled with the gun 12, as shown in FIGS. 1 and 5, squeezing of the handle 16 relative to the body 14 of the gun 12 can result in simultaneous dispensation of the hardener and the resin as described above, through an opening 31 in the proximal end 39 of the cartridge 30. A distal end 47 of the nozzle 40 can be attached to the proximal end 39 of the cartridge 30, as shown in FIGS. 1 and 5, so that the nozzle 40 is in fluid communication with the opening 31 in the proximal end 39 of the cartridge 30, to simultaneously receive the hardener and resin dispensed from the respective first and second chambers (e.g., 32 and 34 in FIG. 5) of the cartridge 30 during squeezing of the handle 16 of the gun 12. In one embodiment, the nozzle 40 can be configured to facilitate mixing of the hardener and the resin during travel thereof from the distal end 47 of the nozzle 40 to a proximal end 49 of the nozzle 40, into the resulting composition 60 which is dispensed from the nozzle 40 through an aperture 42 at the proximal end 49 of the nozzle 40. For example, at least a portion of this mixing can occur at a mixing area 44 shown in FIG. 5. In such a configuration, the hardener and the resin can be mixed, and in one embodiment completely or fully mixed, upon dispensation from the aperture 42. The nozzle 40 can be similar to that shown in FIG. 2 of U.S. Pat. No. 7,237,693, or can have any of a variety of other suitable configurations.

A method of using the applicator assembly 10, in accordance with one embodiment, will now be described. In particular, the cartridge 30 can be coupled with the gun 12 as shown in FIG. 1. Either prior to coupling with the gun 12, or after coupling with the gun 12, the opening 31 in the proximal end 39 of the cartridge 30 can be opened. The nozzle 40 can then be attached to the proximal end 39 of the cartridge 30 such that the nozzle 40 is provided in fluid communication with the opening 31 in the proximal end 39 of the cartridge 30, and with each of the respective chambers (e.g., 32, 34) of the cartridge 30 (e.g., containing the hardener and the resin, respectively). The handle 16 can be squeezed relative to the body 14, one or more times, until the piston 18 moves adequately proximally relative to the cartridge 30 to facilitate dispensation of the composition 60 through the aperture 42 in the nozzle 40.

In the example of FIG. 2, the composition 60 is shown to be dispensed, from the applicator assembly 10, onto edges of horizontal stair surfaces (e.g., 52) and vertical stair surfaces (e.g., 54) of the staircase 50. In one embodiment, the composition 60 is dispensed from the aperture 42 in a ⅛″ (3.2 mm) to ½″ (12.7 mm) bead, such as depending upon the configuration of the nozzle 40, though it will be appreciated that the composition 60 can be dispensed to have any of a variety of other suitable bead sizes. In one embodiment, the proximal end 49 of the nozzle 40 can be cut to length to facilitate selection of a desired size of the aperture 42 and resultant bead size for dispensed composition 60. As the hardener and resin of the epoxy begin to mix, e.g., upon entry into the nozzle 40, the epoxy can start to cure. When the composition 60 is dispensed through the aperture 42 in the nozzle 40, the composition 60 can already have begun curing.

In one embodiment, prior to application of the composition 60 onto surfaces of the staircase 50, those surfaces can be cleaned with one or more chemicals and/or abrasive pads, or otherwise, and/or in some cases painted with a white or other light-colored shellac based primer or other paint or coating. Prior to or after any such cleaning and/or painting, masking tape, foam spacer tape, or other masking or tape (e.g., 56) can be applied to portions of those surfaces, such as generally shown in FIG. 2, to define target areas for application of the composition 60.

Once applied, the composition 60 can be in a gel type state and can self-level, in one embodiment. Alternatively, the composition 60 can be smoothed with a paint brush, foam brush, putty knife or otherwise. Grit (not shown) can be sprinkled onto the composition 60 prior to full curing of the composition 60, in one embodiment, to provide anti-skid or other surface texture. Following application of the composition 60 (and, in some cases, grit), the tape (e.g., 56) can be removed, such as for example approximately 1-2 hours after the dispensation of the composition 60 from the nozzle 40, but prior to full curing of the composition 60. In other embodiments, the tape (e.g., 56) might not be removed until after full curing of the composition 60. The tape (e.g., 56) can accordingly control placement of the composition 60 before it fully cures, to help facilitate a clean/sharp line edge of the composition 60 once cured. The composition 60 can then be allowed to set, dry, and/or cure. With the composition 60 smoothed and tape (e.g., 56) removed, the staircase 50 can appear as in FIG. 3.

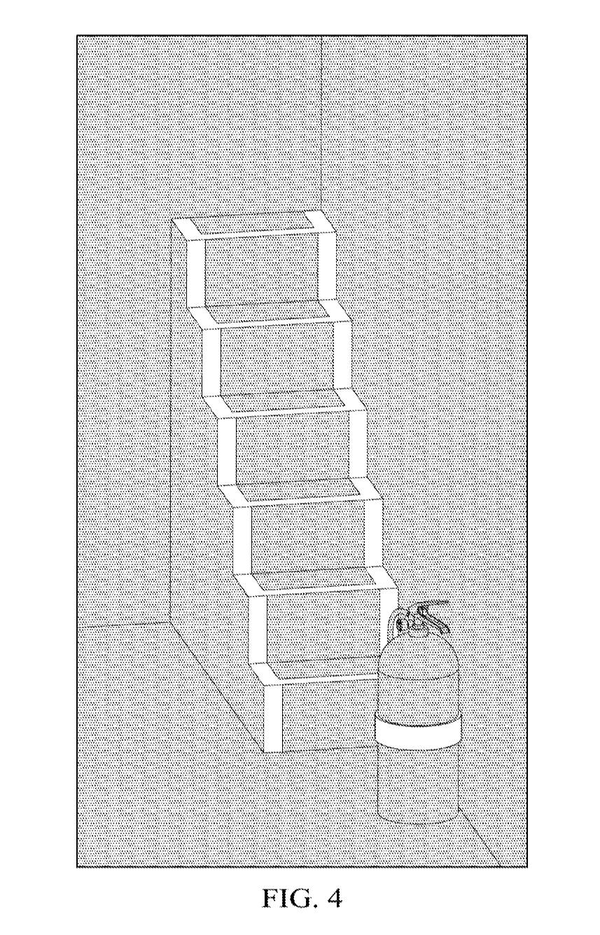

In one embodiment, the composition 60 can dry to the touch within 12 hours, and can be walked on in 24 hours. When ambient light is removed, the composition 60 on the staircase 50 can be visible as shown in FIG. 4. More particularly, the phosphorescent material present in the composition 60 can provide a “glow” once ambient light is removed, thus enabling an operator to effectively see an outline of the staircase 50, as shown in FIG. 4. It will be appreciated that any of a variety of additional or alternative steps can be employed to facilitate application of the composition 60 to a surface.

Following dispensation of composition 60 from the nozzle 40, the nozzle 40 can be removed and discarded, and the opening at the proximal end 39 of the cartridge 30 can be capped such that any remaining hardener and resin contained in the cartridge 30 can be saved for a later application. It will be appreciated that the applicator assembly 10 allows the composition containing the phosphorescent material to stay in an unmixed and uncured form until it is ready to be applied to a surface, and facilitates proper and effective mixing of the hardener and the resin in direct and simple response to an operator's squeezing of the handle 16 of the gun 12. The cartridge 30 can be used in conjunction with any of a variety of conventional guns (e.g., 12). In one embodiment, a chemical and/or abrasive pad, a brush or putty knife, grit, and/or a paint or coating, can be provided along with one or more of the cartridges 30 and/or the nozzles 40, as part of a kit. While the applicator assembly 10 can be used by an operator to efficiently and effectively provide line stripes or other markings on floor surfaces, e.g., of a staircase or other factory/warehouse floor, it will be appreciated that the applicator assembly 10 can be used with any of a variety of other surfaces.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art.

1. A method of using an applicator assembly, the method comprising:
coupling a cartridge with a gun, such that a piston of the gun enters a bore in a distal end of the cartridge, the cartridge comprising a first chamber and a second chamber, the first chamber filled at least partially with a hardener, and the second chamber filled at least partially with a resin, wherein at least one of the resin and the hardener comprises a phosphorescent material;
providing an opening in a proximal end of the cartridge;
attaching a distal end of a nozzle to the proximal end of the cartridge, such that the nozzle is provided in fluid communication with the opening, the first chamber, and second chamber;
moving the piston proximally relative to the cartridge to facilitate simultaneous dispensation of the hardener and the resin through the opening and into the nozzle;
mixing, within the nozzle, the hardener and the resin into a composition, the composition comprising an epoxy; and
dispensing the composition through an aperture in a proximal end of the nozzle.

2. (canceled)

3. The method of claim 1 further comprising cutting the proximal end of the nozzle to facilitate a desired bead size for dispensed composition, wherein the cutting of the proximal end of the nozzle facilitates a bead size of the dispensed composition of between ⅛″ and ½″.

4. (canceled)

5. The method of claim 1 wherein the dispensing comprises application of the composition onto a surface.

6. The method of claim 5 wherein the surface comprises horizontal and vertical stair surfaces of a staircase.

7. The method of claim 5 wherein, prior to the dispensing, cleaning the surface with at least one of a chemical and an abrasive pad.

8. The method of claim 7 wherein, prior to the dispensing, and subsequent to the cleaning, painting the surface with a light-colored coating.

9. The method of claim 5 wherein:
prior to the dispensing, applying masking tape to the surface; and
subsequent to the dispensing, removing the masking tape from the surface.

10. (canceled)

11. The method of claim 5 wherein:
the composition is dispensed in a gel state; and
following application of the composition to the surface, the composition self-levels.

12. (canceled)

13. The method of claim 5 wherein, following application of the composition to the surface, smoothing the composition with one of a brush and a putty knife.

14. The method of claim 5 wherein, following application of the composition to the surface, further comprising sprinkling grit onto the composition to provide surface texture.

15. The method of claim 1 wherein, following the dispensing, removing and discarding the nozzle, and then capping the opening.

16. (canceled)

17. The method of claim 5 wherein the surface comprises a floor surface, and wherein the dispensed composition defines floor striping.

18. (canceled)

19. (canceled)

20. (canceled)

21. (canceled)

22. (canceled)

23. The method of claim 1 wherein the phosphorescent material comprises a phosphorescent phosphor, and wherein the phosphorescent phosphor comprises at least one of a photoluminescent strontium aluminum based pigment and a photoluminescent zinc oxide based material.

24. (canceled)

25. (canceled)

26. The method of claim 23 wherein the phosphorescent phosphor further comprises at least one material configured to prevent pigment settling and ensure emulsion.

27. (canceled)

28. (canceled)

29. A cartridge comprising:
a side wall defining a cylindrical exterior shape extending coaxially about a longitudinal axis between opposed distal and proximal ends, wherein the distal end opens to a bore defined at least partially by the side wall, the bore configured to selectively receive at least a portion of a piston of a gun;
a first chamber disposed at least partially within the bore and filled at least partially with a first component;
a second chamber disposed at least partially within the bore and filled at least partially with a second component; and
an opening defined in the proximal end and in fluid communication with the first chamber and the second chamber; wherein:
the first component and the second component are configured to simultaneously dispense through the opening in selective response to movement of a piston of a gun within the bore; and
at least one of the first component and the second component comprises a phosphorescent material.

30. The cartridge of claim 29 wherein the phosphorescent material comprises a phosphorescent phosphor, and wherein the phosphorescent phosphor comprises at least one of a photoluminescent strontium aluminum based pigment and a photoluminescent zinc oxide based material.

31. (canceled)

32. (canceled)

33. The cartridge of claim 30 wherein the phosphorescent phosphor further comprises at least one material configured to prevent pigment settling and ensure emulsion.

34. The cartridge of claim 30 wherein:
the first component comprises a hardener;
the second component comprises a resin; and
the hardener and the resin, when mixed, form an epoxy.

35. (canceled)

36. (canceled)

37. (canceled)

38. (canceled)

39. An applicator assembly comprising the cartridge of claim 29 in combination with a nozzle, the nozzle comprising:
a distal end and a proximal end, the proximal end of the nozzle defining an aperture, and the distal end of the nozzle being configured for attachment to the proximal end of the cartridge such that the nozzle is in fluid communication with the opening, the first chamber, and second chamber,
wherein the nozzle is configured such that the first component and the second component mix together when travelling from the distal end of the nozzle to the proximal end of the nozzle, prior to dispensing through the aperture.

40. (canceled)

41. (canceled)

42. (canceled)

43. A kit comprising the applicator assembly of claim 39 in combination with at least one of a chemical cleaner, an abrasive pad, a brush, a putty knife, grit, and a coating.
